(19) United States
(12) Patent Application Publication
(10) Pub. No.: US 2026/0279179 A1
(43) Pub. Date: Sep. 17, 2026

(54) PARTIAL OPEN CHAMBER DETECTOR

(71) Applicant: Microchip Technology Inc., Chandler, AZ (US)

(72) Inventors: Arthur B. Eck, Gilbert, AZ (US); Jonathan Corbett, Havertown, PA (US); Patrick McFarland, Gilbert, AZ (US)

(73) Assignee: Microchip Technology Inc., Chandler, AZ (US)

(21) Appl. No.: 19/243,040

(22) Filed: Jun. 19, 2025

Related U.S. Application Data
(60) Provisional application No. 63/770,302, filed on Mar. 11, 2025.

(51) Int. Cl. G08B 17/107

(52) U.S. Cl. CPC G08B 17/107

(57) ABSTRACT

An apparatus comprises a detector configured to be mounted to a ceiling of a room. The detector includes a crossfire sensor arranged to fire in a direction parallel to a surface of the ceiling. The apparatus further comprises a shade mounted to the detector and having a shading surface arranged parallel to the surface of the ceiling and between the room and the crossfire sensor.

### PRIORITY

This application claims priority to commonly owned United States Provisional Patent Application No. 63/770,302 filed Mar. 11, 2025, the entire contents of which are hereby incorporated by reference for all purposes.

### TECHNICAL FIELD

The present disclosure relates to monitoring systems and methods. Various examples of the teachings herein include systems and/or methods for reducing interference in monitoring systems, such as smoke detectors and carbon monoxide detectors.

### BACKGROUND

Currently available monitoring systems and sensors, for example, carbon monoxide and smoke detectors, have become a standard safety feature in residential and commercial buildings, playing a crucial role in early fire and carbon monoxide detection and prevention of loss of life and property damage. These devices are typically mounted on ceilings or walls to monitor the air for the presence of smoke particles and carbon monoxide, triggering an alarm when one or both are detected.

Traditional monitoring systems are often designed as standalone units that protrude from the surface they are mounted on. While functional, these protruding designs can be visually obtrusive and may not align well with interior design aesthetics.

Additionally, in the field of electronic devices including monitoring systems and sensors, the signal to noise ratio generated by the sensors affects device performance. The operation of environmental sensors such as smoke detectors and other life safety monitors may be compromised by increases in the amount of noise in any given signal. The baseline amount of noise may be referred to as a “noise floor.” The higher the noise floor for a given monitoring system, the more amplification and/or signal processing is required including, but not limited to, larger driver circuits, extra batteries, or power loops.

Some smoke detectors employ a light sensor to measure light reflected by smoke particles present in a darkened test chamber to indicate the presence of smoke. This may include generating light in one part of the smoke detector and measuring it in another. The traditional approach to room chamber detectors is to fire down into the room and receive the reflection from the room. This approach leaves the detector sensor open to any room light, for example, light shined from within the room toward the detector. Extraneous light impinging on the light sensor may interfere with accurate sensing and increasing noise. To avoid such additional noise, some smoke detectors include a housing with baffles allowing smoke particles to enter the test chamber through an indirect path that reduces the entry of external light.

Inventors of various examples of the present disclosure have recognized that baffled chambered smoke detectors have airflow issues over time due to debris build-up in baffles. Inventors of various examples of the present disclosure have also recognized that elaborate baffled chambers can increase design cost and cost of these smoke detectors. On the other hand, open chamber designs may cause false tripping or indicate inoperability due to room light triggering the sensor. Various examples described herein may address one or more of these issues.

### SUMMARY

The examples herein enable monitoring systems, for example, smoke detectors, carbon monoxide detectors, among other detectors, implemented in a cost-efficient and aesthetically pleasing way.

According to one example, an apparatus is provided that includes a detector configured to be mounted to a ceiling of a room, the detector comprising a crossfire sensor arranged to fire in a direction parallel to a surface of the ceiling, and wherein the apparatus further includes a shade mounted to the detector and having a shading surface arranged parallel to the surface of the ceiling and between the room and the crossfire sensor. In one example, the crossfire sensor comprises a sender and a receiver, wherein the sender is configured to fire into a reflected detection path of the receiver, and wherein the crossfire sensor is configured to generate a signal representing illuminance in the reflected detection path of the receiver. In the same or different examples, the shade is configured to at least partially block light from the room from being detected by the crossfire sensor. In the same or different examples, the shade comprises a permeable material configured to at least partially block light from passing therethrough. In the same or different examples, the shade is configured to permit air flow along a direct path from the room into a reflected detection path of the detector. In the same or different examples, the detector comprises at least one of a smoke detector and a carbon monoxide detector. In the same or different examples, the crossfire sensor is configured to be located at least partially below the surface of the ceiling when the detector is mounted in a recess of the ceiling. In the same or different examples, the shade has an L-shape configuration. In the same or different examples, the shading surface of the shade has rectangular shape configured to be oriented parallel to the surface of the ceiling when the detector is mounted in the recess, wherein the shade further includes a first side member coupled to a first edge of the shading surface of the shade and configured to extend to the ceiling when the detector is mounted in the recess; a second side member coupled to a second edge of the shading surface of the shade and configured to extend to the ceiling when the detector is mounted in the recess; and a third side member coupled to a third edge of the shading surface of the shade and configured to extend to the ceiling when the detector is mounted in the recess. In the same or different examples, the crossfire sensor is located in a cavity of the detector and configured to be located above the surface of the ceiling when the detector is mounted in a recess of the ceiling. In the same or different examples, the shade comprises a T-shaped member coupling the shading surface of the shade to the detector.

According to another example, an apparatus is provided that includes a detector configured to be mounted to a wall of a room, wherein the detector comprises a crossfire sensor arranged to fire in a direction parallel to a surface of the wall facing the room, and wherein the apparatus further includes a shade mounted to the detector and having a shading surface arranged parallel to the surface of the wall and between the room and the crossfire sensor. In one example, the crossfire sensor comprises a sender and a receiver, wherein the sender is configured to fire into a reflected detection path of the receiver, and wherein the crossfire sensor is configured to generate a signal representing illuminance in the reflected detection path of the receiver. In the same or different examples, the shade is configured to permit air flow along a direct path from the room into a reflected detection path of the detector. In the same or different examples, the detector comprises at least one of a smoke detector and a carbon monoxide detector. In the same or different examples, the crossfire sensor is configured to be located at least partially interior to the surface of the wall when the detector is mounted in a recess of the wall. In the same or different examples, the crossfire sensor is located in a cavity of the detector and configured to be located exterior to the surface of the wall when the detector is mounted in a recess of the wall.

Another example provides a method which may include mounting the detector in a recess of a ceiling, shading a reflected detection path of a crossfire sensor of the detector from light projecting from a room and toward the detector, permitting air flow along a direct path from the room and into the reflected detection path of the crossfire sensor, firing the crossfire sensor in a direction parallel to a surface of the ceiling facing the room, and detecting a hazard based on an illuminance in the reflected detection path of the crossfire sensor. In some examples, detecting the hazard comprises detecting a presence of at least one of carbon monoxide and smoke. In the same or different examples, the crossfire sensor is located at least partially below the surface of the ceiling. In the same or different examples, the crossfire sensor is located in a cavity of the detector above the surface of the ceiling.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1A illustrates a front cross-section view of an apparatus in accordance with various examples of the present disclosure.

FIG. 1B illustrates a bottom view of an apparatus in accordance with various examples of the present disclosure.

FIG. 1C illustrates a side cross-section view of an apparatus in accordance with various examples of the present disclosure.

FIG. 1D illustrates a perspective view of a shade in accordance with various examples of the present disclosure.

FIG. 1E illustrates a perspective view of a shade in accordance with various examples of the present disclosure.

FIG. 2A illustrates a front cross-section view of an apparatus in accordance with various examples of the present disclosure.

FIG. 2B illustrates a bottom view of an apparatus in accordance with various examples of the present disclosure.

FIG. 2C illustrates a side cross-section view of an apparatus in accordance with various examples of the present disclosure.

FIG. 2D illustrates a side cross-section view of an apparatus in accordance with various examples of the present disclosure.

FIG. 3 illustrates a flow chart for a method of operating a detector in accordance with various examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

The following description sets forth example aspects of the present disclosure. Such description is not intended as a limitation on the scope of the present disclosure. Rather, the description also encompasses combinations and modifications to those example aspects described herein.

The teachings of the present disclosure may be employed to provide a partially open detector while reducing or eliminating the unsightliness of a monitoring system (such as smoke detector or a carbon monoxide detector). In some examples, the teachings include systems and/or methods to mount a monitoring system in a recess in a ceiling or in a wall (for example, outside of room) while locating a shade in the room. In some examples, the recess may include a pre-existing, standard utility box found in an existing building (for example a home, office, commercial space, or industrial space). In other examples, the monitoring system may be recessed into a standard utility box for installation in a new building.

According to these examples, the monitoring system may blend better into the environment while allowing for a partial open detection. Because the detector may be out of room (for example recessed into a utility box) and the shade is in room, a smoke detector may not take up significant space in the room. This may create an incentive for replacing existing (unsightly) monitoring systems with the attractive monitoring systems of the present disclosure. Additionally, example monitoring systems with crossfire sensors with a shade may achieve better monitoring performance because the sensors may not be in line with the room light (thereby mitigating the issue of room-light interference) and may eliminate a requirement for complicated baffles that suffer from debris build up. According to examples of the present disclosure, a detector is achieved that meets the desire to have a smaller more visually appealing room footprint without being highly subject to interference from lights in the room and from windows. Various examples of the present disclosure may thus provide detection (for example smoke or carbon monoxide detection) that is less costly and more robust. Various monitoring systems and detectors according to the present disclosure may achieve out of room, chamber-less detection while avoiding the room light interference issues and insect and debris build-up issues.

The inventors of embodiments of the present disclosure have recognized the benefit of monitoring systems that can seamlessly integrate into living spaces without compromising safety, functionality, or aesthetics. This disclosure presents a detector, for example, a smoke detector, which may be mounted to a ceiling or a wall of a room (for example in a recess of the ceiling or the wall). The detector may include a crossfire sensor that may crossfire parallel to the surface of the ceiling or wall. The detector may be fully or partially recessed in the ceiling or the wall and covered by a mostly open shade or shroud cover. For example, the body of the detector may be fully recessed within the ceiling or the wall, while the crossfire sensor of the detector may be located either in the room (projecting out from surface of ceiling or wall) or may be located within a cavity in the body of the detector. By providing a partially open detector with a shade that at least partially blocks light from the room, the accuracy of the detector may be improved relative to fully open chamber detectors. Further, the shade may provide for a more appealing aesthetic compared to prior detectors that fully protruded into the room.

For the purposes of the present disclosure, a monitoring system or a detector refers to an electronic device that monitors or detects one or more hazards (such as the presence of smoke, carbon monoxide, or other hazardous gas) or environmental condition (such as humidity). A sensor may refer to a specific element within such a monitoring system or detector configured to detect a particular parameter that may be indicative of the hazard or environmental condition.

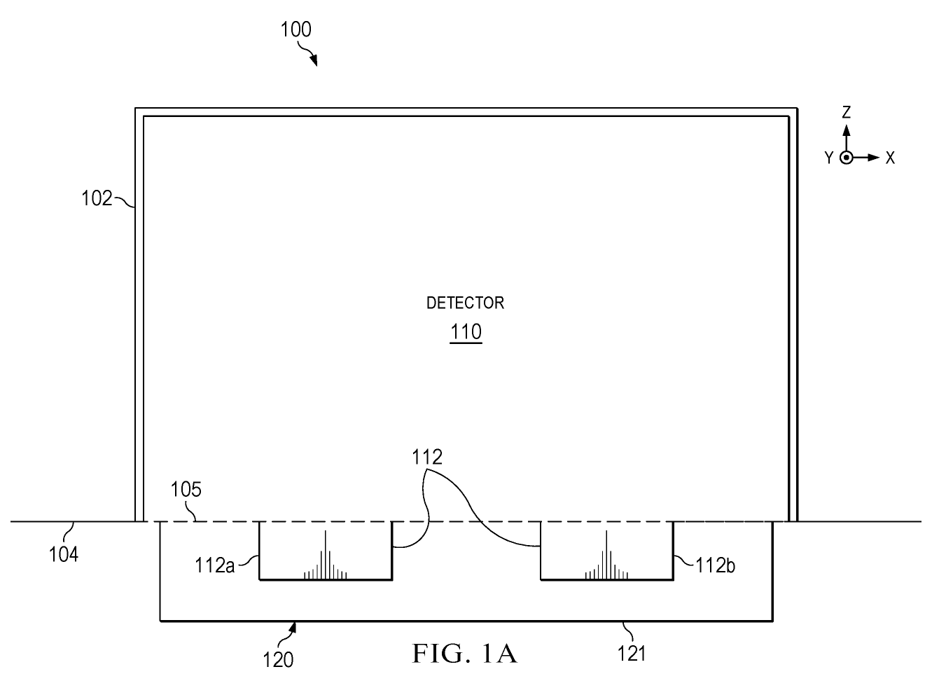

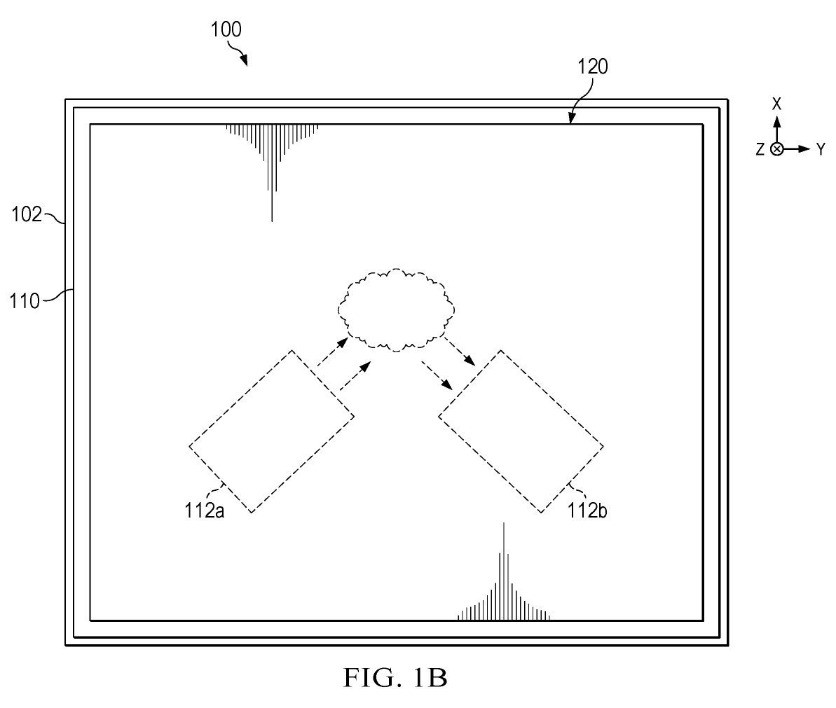

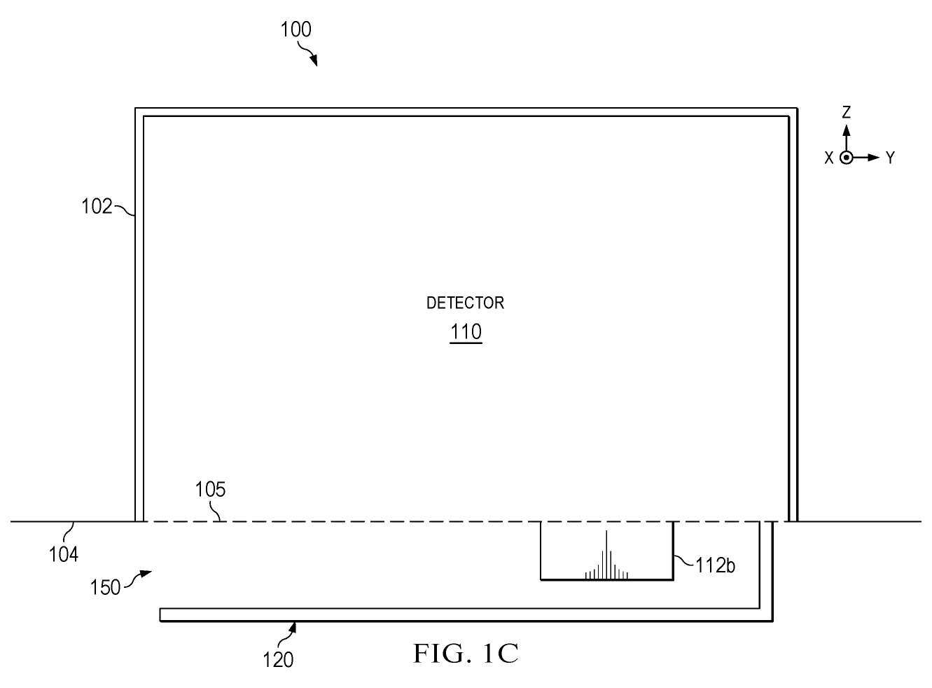

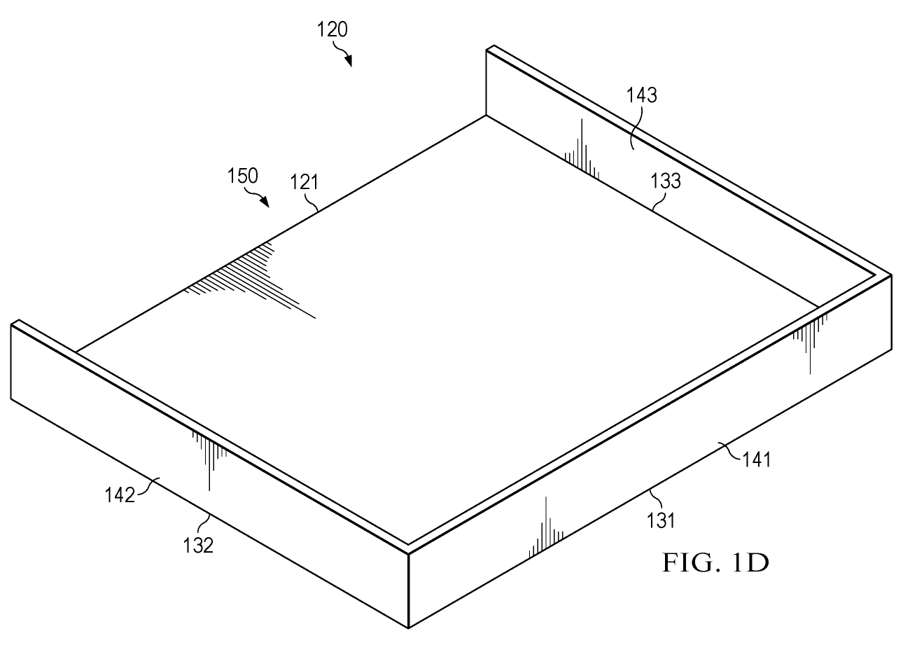

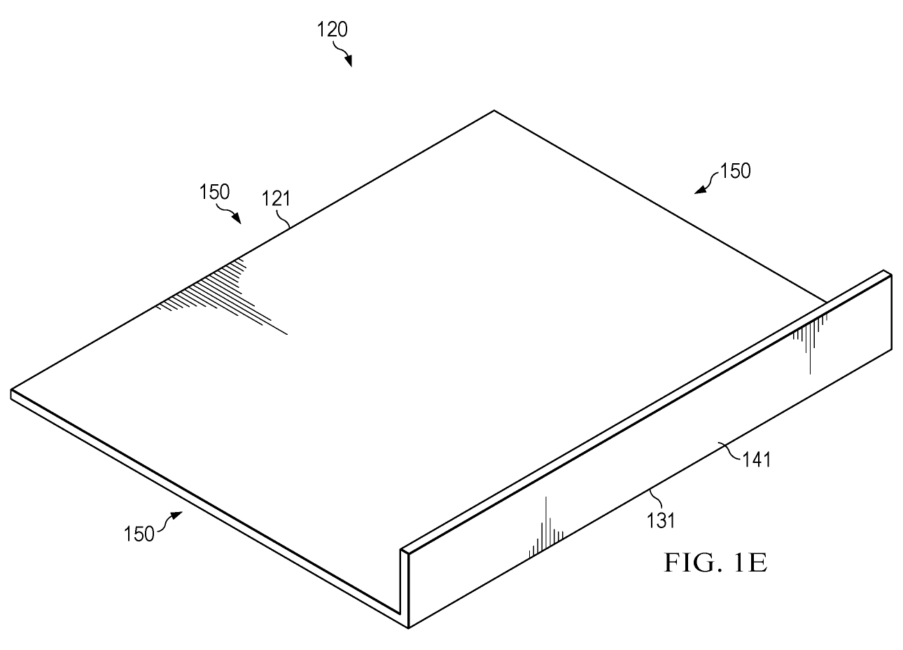

FIG. 1A illustrates a front cross-section view of apparatus 100 in accordance with various examples of the present disclosure. For the purpose of orienting the view of FIG. 1A versus the respective views of other FIGURES included herein, FIG. 1A may be considered a cross-section view of apparatus 100 along the x-z plane looking in the direction of the y-axis into the page. Apparatus 100 may be implemented in any suitable fashion according to the operation described in the present disclosure.

As shown in FIG. 1A, apparatus 100 may include detector 110. Detector 110 may include at least one of a smoke detector and a carbon monoxide detector. For example, detector 110 may be configured to detect the presence of smoke, the presence of carbon monoxide, or both. Detector 110 may be configured to be mounted to a ceiling of a room. For example, detector 110 may be configured to be mounted in a recess 105 in a ceiling 104 of a room. In some embodiments, detector 110 may be mounted within a utility box 102 aligned with recess 105 of ceiling 104. Detector 110 may comprise a crossfire sensor 112 arranged to fire in a direction parallel to a ceiling surface that faces the room. Crossfire sensor 112 may be implemented in any suitable fashion according to the operation described in the present disclosure. For example, crossfire sensor 112 may include a sender 112a and a receiver 112b. The sender 112a may be configured to fire into a reflected detection path of receiver 112b. For example, sender 112a may project light into the reflected detection path of receiver 112b. Receiver 112b may in turn detect the amount of light reflected (for example by particles of smoke) within the reflected detection path. Crossfire sensor 112 may be configured to generate a signal representing the illuminance in the reflected detection path of receiver 112b. The illuminance caused by reflected light may indicate the presence of smoke or other harmful gasses in the reflected detection path of receiver 112b.

As shown in FIG. 1A, apparatus 100 may also include shade 120 mounted to detector 110. In various examples, shade 120 may have a shading surface 121 arranged parallel to the surface of the ceiling and between the room and crossfire sensor 112. As described in further detail below with reference to FIGS. 1B-1E, shade 120 may be configured to at least partially block light from the room below from being detected by crossfire sensor 112. For example, in various examples, shade 120 may include a permeable material configure to at least partially block light from passing therethrough, from the room and into the reflected detection path of crossfire sensor 112.

FIG. 1B illustrates a bottom view of an apparatus in accordance with various examples of the present disclosure. FIG. 1B may represent of view of apparatus 100 from the perspective of looking up from a room to the ceiling where detector 110 may be mounted. For the purpose of orienting the view of FIG. 1B versus the respective views of other FIGURES included herein, FIG. 1B may be considered a bottom view of apparatus 100 along the x-y plane looking in the direction of the z-axis into the page.

As described above with reference to FIG. 1A, shade 120 may be configured to block light from the room from being detected by crossfire sensor 112 formed by sender 112a and receiver 112b. Nonetheless, shade 120 is drawn transparently in FIG. 1B to show the orientation of crossfire sensor 112 (including sender 112a and receiver 112b) from a bottom view perspective. As depicted in FIG. 1B, crossfire sensor 112 may be arranged to fire in a direction parallel to the ceiling surface. Sender 112a may fire into a reflected detection path of receiver 112b that is parallel to the surface of the ceiling. For example, sender 112a may project light into the reflected detection path of receiver 112b. Receiver 112b may in turn detect the amount of light reflected (for example by particles of smoke) within the reflected detection path of receiver 112b. Because receiver 112b forms a portion of crossfire sensor 112 of detector 110, the reflected detection path of receiver 112b may also be referred to herein as the reflected detection path of crossfire sensor 112 or as the reflected detection path of detector 110.

FIG. 1C illustrates a side cross-section view of apparatus 100 in accordance with various examples of the present disclosure. For the purpose of orienting the view of FIG. 1C versus the respective views of other FIGURES included herein, FIG. 1C may be considered a cross-section view of apparatus 100 along the y-z plane looking in the direction of the x-axis into the page.

Shade 120 may be configured with an at least partially open design to allow air flow into the reflected detection path of detector 110 (into the reflected detection path of the receiver 112b of crossfire sensor 112). For example, as shown in FIG. 1C, shade 120 may be configured to permit air flow 150 along a direct path from the room into a reflected detection path of detector 110. By providing a partially open design for detector 110 with a shade 120 that at least partially blocks light from the room, the accuracy of the detector 110 may be improved relative to fully open chamber detectors. Further, shade 120 may provide for a more appealing aesthetic from the bottom view perspective of room occupants compared to detectors that fully protruded into the room.

As shown in FIG. 1C, the body of detector 110 may be mounted in a recess 105 in ceiling 104. In some examples, such as illustrated in FIGS. 1A and FIG. 1C, crossfire sensor 112 may be configured to be located at least partially below the surface of ceiling 104 when detector 110 is mounted in recess 105. As also shown in FIG. 1C, shade 120 may have an L-shape configuration. As described in further detail below with reference to FIGS. 1D and FIG. 1E, the L-shape configuration may allow direct air flow on one or more sides, while still allowing the shading surface 121 of shade 120 to reduce or eliminate light interference from the room below.

FIG. 1D illustrates a perspective view of an example shade 120 in accordance with various examples of the present disclosure. As shown in FIG. 1D, the shading surface 121 of shade 120 may have a rectangular shape. In some examples, and as shown in FIG. 1A, the rectangular shape may be configured to be oriented parallel to the surface of the ceiling when detector 110 is mounted in the recess 105 of ceiling 104. Referring back to FIG. 1D, shade 120 further includes a first side member 141 coupled to a first edge 131 of shading surface 121 of shade 120 and configured to extend to the ceiling when detector 110 is mounted in the recess. In addition, shade 120 includes a second side member 142 coupled to a second edge 132 of shading surface 121 of shade 120 and configured to extend to the ceiling when detector 110 is mounted in the recess. Further, shade 120 may also include a third side member 143 coupled to a third edge 133 of shading surface 121 of shade 120 and configured to extend to the ceiling when detector 110 is mounted in the recess. The partially open configuration provided by shade 120 may allow direct air flow from the room to the crossfire sensor (shown in FIGS. 1A-1C) while still allowing the shading surface 121 of shade 120 to reduce or eliminate light interference from the room below.

FIG. 1E illustrates a perspective view of an example shade 120 in accordance with various examples of the present disclosure. As shown in FIG. 1E, some examples of shade 120 may include an L-shape with a first side member 141 coupled to a first edge 131 of shading surface 121, and with openings along each of the other three sides of the rectangular shape of shading surface 121. Accordingly, various examples of shade 120 (such as shown in FIG. 1E) may be configured to permit air flow 150 on multiple sides of shade 120. By permitting direct air flow 150 on multiple sides of shade 120, the various examples of detector 110 disclosed herein may achieve out of room, chamber-less detection while avoiding the room light interference issues and insect and debris build-up issues.

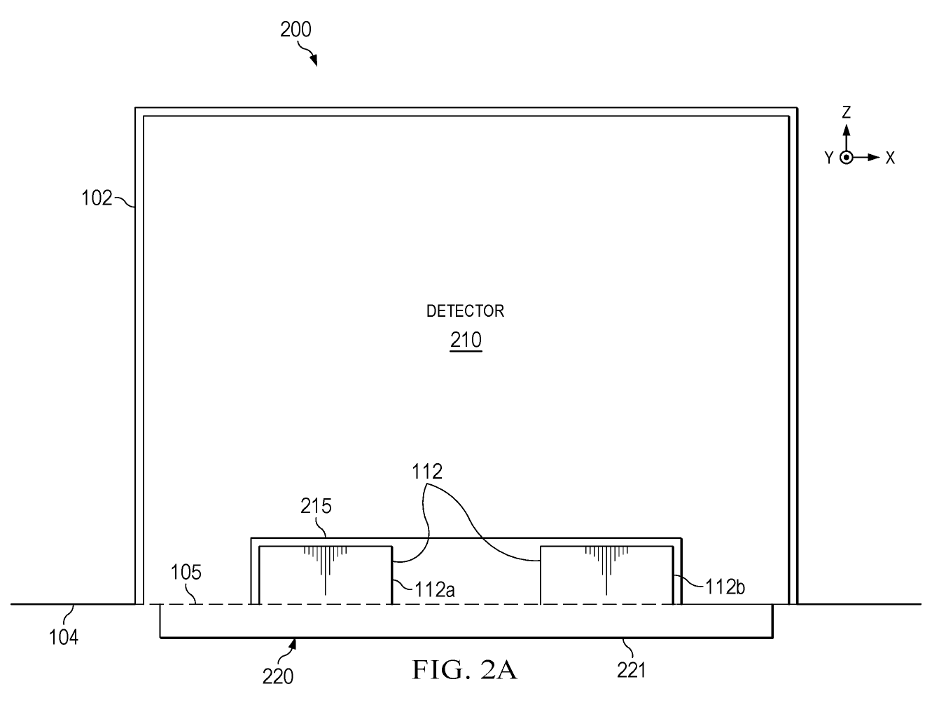

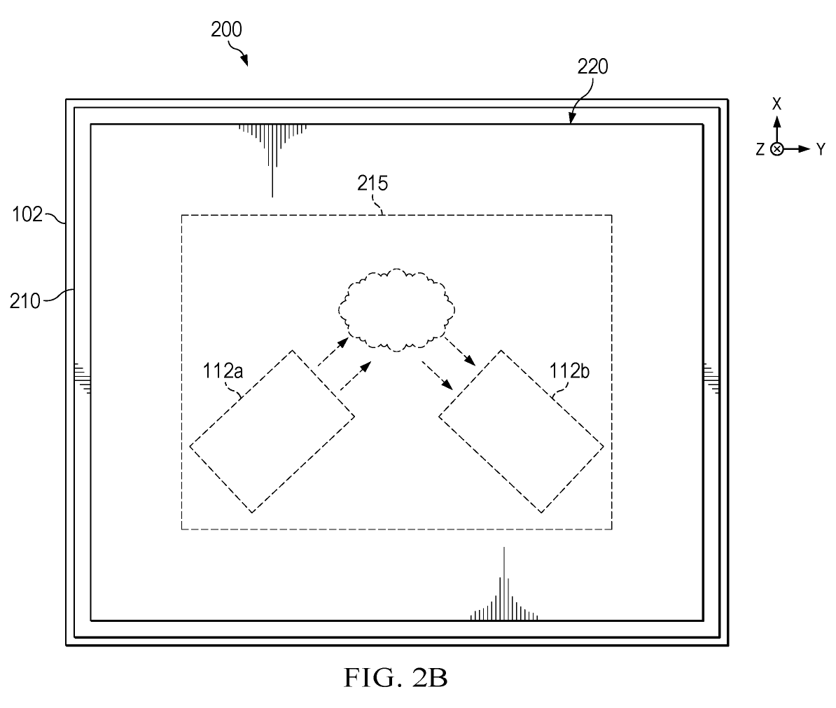

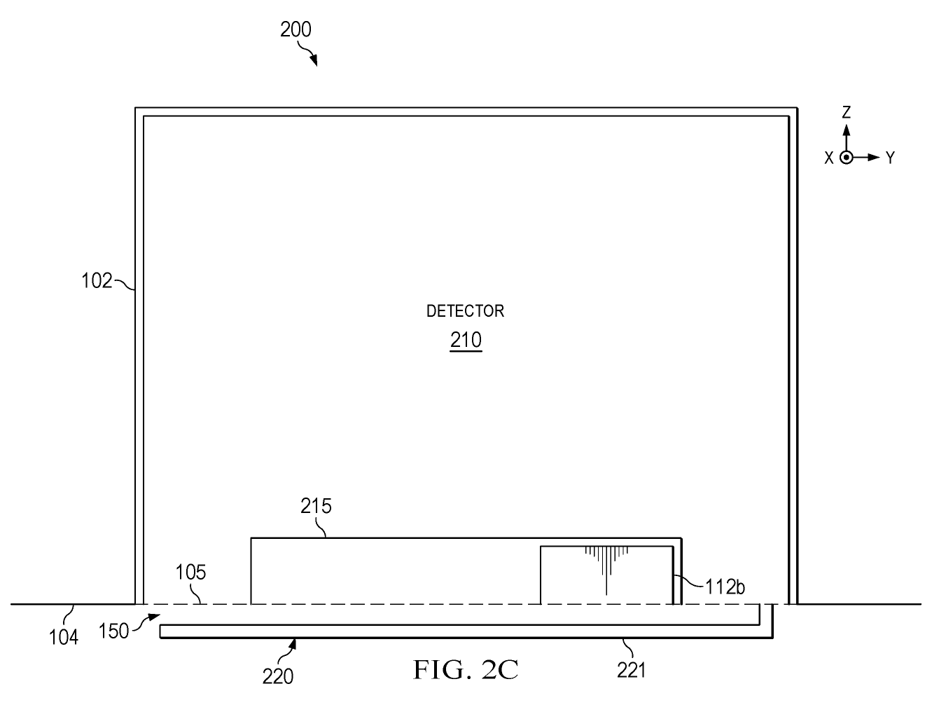

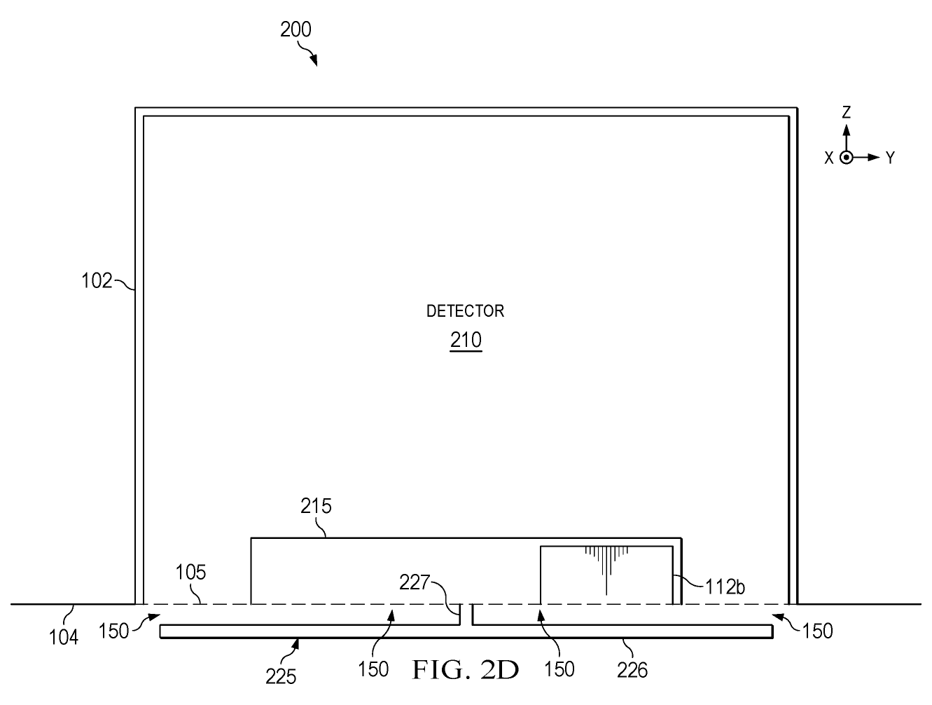

FIG. 2A illustrates a front cross-section view of apparatus 200 in accordance with various examples of the present disclosure. For the purpose of orienting the view of FIG. 2A versus the respective views of other FIGURES included herein, FIG. 2A may be considered a cross-section view of apparatus 200 along the x-z plane looking in the direction of the y-axis into the page. Apparatus 200 may be implemented in any suitable fashion according to the operation described in the present disclosure.

As shown in FIG. 2A, apparatus 200 may include detector 210. Detector 210 may include at least one of a smoke detector and a carbon monoxide detector. For example, detector 210 may be configured to detect the presence of smoke, the presence of carbon monoxide, or both. Detector 210 may be configured to be mounted to a ceiling 104 of a room. For example, detector 210 may be configured to be mounted in a recess 105 in a ceiling 104 of a room. In some embodiments, detector 210 may be mounted within a utility box 102 aligned with recess 105 of ceiling 104. Detector 210 may comprise a crossfire sensor 112. Crossfire sensor 112 may include sender 112a and receiver 112b. Crossfire sensor 112 may operate in the same manner as described above with reference to FIG. 1A. But as shown in FIG. 2A, in some examples, crossfire sensor 112 may be located in a cavity 215 of detector 210. Thus, as shown in FIG. 2A, crossfire sensor 112 may be configured to be located above the surface of ceiling 104 when detector 210 is mounted in the recess 105 of ceiling 104.

In various examples, crossfire sensor 112 may be arranged to fire in a direction parallel to a ceiling surface that faces the room. Sender 112a may be configured to fire into a reflected detection path of receiver 112b. For example, sender 112a may project light into the reflected detection path of receiver 112b. Receiver 112b may in turn detect the amount of light reflected (for example by particles of smoke) within the reflected detection path. Crossfire sensor 112 may be configured to generate a signal representing the illuminance in the reflected detection path of receiver 112b. The illuminance caused by reflected light may indicate the presence of smoke or other harmful gasses in the reflected detection path of receiver 112b.

As shown in FIG. 2A, apparatus 200 may also include shade 220 mounted to detector 210. In various examples, shade 220 may have a shading surface 221 arranged parallel to the surface of the ceiling and between the room and crossfire sensor 112. As described in further detail below with reference to FIGS. 2B-2D, shade 220 may be configured to at least partially block light from the room below from being detected by crossfire sensor 112. In various examples, shade 220 may include a permeable material configure to at least partially block light from passing therethrough, from the room and into the reflected detection path of crossfire sensor 112.

FIG. 2B illustrates a bottom view of apparatus 200 in accordance with various examples of the present disclosure. For example, FIG. 2B may represent of view of apparatus 200 from the perspective of looking up from a room to the ceiling where detector 210 may be mounted. For the purpose of orienting the view of FIG. 2B versus the respective views of other FIGURES included herein, FIG. 2B may be considered a bottom view of apparatus 200 along the x-y plane looking in the direction of the z-axis into the page.

As described above with reference to FIG. 2A, shade 220 may be configured to block light from the room from being detected by crossfire sensor 112 formed by sender 112a and receiver 112b. Nonetheless, shade 220 is drawn transparently in FIG. 2B to show the orientation of crossfire sensor 112 (including sender 112a and receiver 112b) from a bottom view perspective. As depicted in FIG. 2B, crossfire sensor 112 may be located in cavity 215 of detector 210. Within cavity 215 of detector 210, crossfire sensor 112 may be arranged to fire in a direction parallel to the ceiling surface. Specifically, sender 112a may fire into a reflected detection path of receiver 112b that is parallel to the surface of the ceiling. For example, sender 112a may project light into the reflected detection path of receiver 112b. Receiver 112b may in turn detect the amount of light reflected (for example by particles of smoke) within the reflected detection path of receiver 112b. Because receiver 112b forms a portion of crossfire sensor 112 of detector 210, the reflected detection path of receiver 112b may also be referred to herein as the reflected detection path of crossfire sensor 112 or as the reflected detection path of detector 210.

FIG. 2C illustrates a side cross-section view of apparatus 200 in accordance with various examples of the present disclosure. For the purpose of orienting the view of FIG. 2C versus the respective views of other FIGURES included herein, FIG. 2C may be considered a cross-section view of apparatus 200 along the y-z plane looking in the direction of the x-axis into the page.

Shade 220 may be configured with an at least partially open design to allow air flow into the reflected detection path of detector 110 (into the reflected detection path of the receiver 112b of crossfire sensor 112). For example, as shown in FIG. 2C, shade 220 may be configured to permit air flow 150 along a direct path from the room into a reflected detection path of detector 210. By providing a partially open design for detector 210 with a shade 220 that at least partially blocks light from the room, the accuracy of the detector 210 may be improved relative to fully open chamber detectors. Further, shade 220 may provide for a more appealing aesthetic from the bottom view perspective of room occupants compared to detectors that fully protruded into the room.

In some examples, shade 220 may have an L-shape configuration similar to that of the examples of shade 120 shown in FIGS. 1D and FIG. 1E. In some examples, shade 220 may be open along one side of shading surface 221, similar to the example of shade 120 in FIG. 1D. In other examples, shade 220 may be partially open along multiple sides of shading surface 221, similar to the example of shade 120 in FIG. 1E. As compared to shade 120, however, shading surface 221 may be located closer to the surface of ceiling 104 given the location of crossfire sensor 112 (including sender 112a and receiver 112b) in the cavity 215 of detector 210.

FIG. 2D illustrates a side cross-section view of apparatus 200 in accordance with various examples of the present disclosure. For the purpose of orienting the view of FIG. 2D versus the respective views of other FIGURES included herein, FIG. 2D may be considered a cross-section view of apparatus 200 along the y-z plane looking in the direction of the x-axis into the page. The example of apparatus 200 shown in FIG. 2D may be similar to the example of apparatus 200 shown in FIGS. 2A-2C, but may include a shade 225 comprising a T-shaped member 227 coupling the shading surface 226 of shade 225 to detector 210. The configuration of shade 225 with T-shaped member 227, may allow for air flow 150 along all four sides of shading surface 226. By permitting direct air flow 150 on multiple sides of shade 220, the various examples of detector 210 disclosed herein may achieve out of room, chamber-less detection while avoiding the room light interference issues and insect and debris build-up issues.

Although various examples of apparatus 100 and apparatus 200 have been illustrated with detectors (such as detector 110 and detector 210) and shades (such as shade 120, shade 220, and shade 225) mounted relative to a recess in a ceiling of a room, some examples of apparatus 100 and apparatus 200 may also be mounted relative to a recess in a wall of a room. For example, with respect to FIG. 1A, ceiling 104 may instead be a vertical wall (the x-axis may be parallel to the vertical wall of a room), with detector 110 mounted horizontally into the recess of the wall. Likewise, with respect to FIG. 2A, ceiling 104 may instead be a vertical wall (the x-axis may be parallel to the vertical wall of a room), with detector 210 mounted horizontally into the recess of the wall. In such embodiments, the detector (such as detector 110 or detector 210) may be configured to be mounted in a recess of a wall of the room, wherein the detector comprises a crossfire sensor (such as crossfire sensor 112) arranged to fire in a direction parallel to a surface of the wall that faces the room. Further, in such embodiments, the shade (such as shade 120, shade 220, or shade 225) may be mounted to the detector and have a shading surface arranged parallel to the surface of the wall and between the room and the crossfire sensor. Consistent with the examples shown in FIGS. 1A-1E, the crossfire sensor may be configured to be located at least partially interior to the surface of the wall when the detector is mounted in the recess of the wall. And consistent with the examples shown in FIGS. 2A-2D, the crossfire sensor may be located in a cavity of the detector and configured to be located exterior to the surface of the wall when the detector is mounted in the recess of the wall.

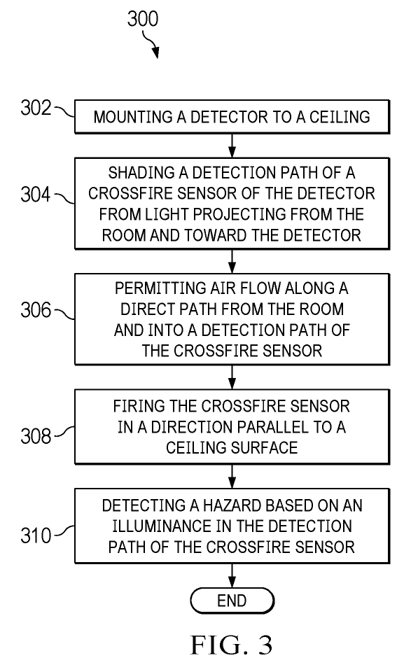

FIG. 3 illustrates a flow chart for a method 300 of operating a detector in accordance with various examples of the present disclosure. According to one example, method 300 may begin at block 302. Teachings of the present disclosure may be implemented in a variety of configurations of apparatus 100 and apparatus 200. As such, the initialization point for method 300 and the order of 302-310 comprising method 300 may depend on the implementation chosen.

At block 302, a detector may be mounted to a ceiling. At block 304, a reflected detection path of a crossfire sensor of the detector may be shaded from light projecting from a room and toward the detector. At block 306, air flow may be permitted along a direct path from the room and into a reflected detection path of the crossfire sensor. At block 308, the crossfire sensor may be fired in a direction parallel to a surface of the ceiling facing the room. In some examples, the crossfire sensor may be located at least partially below a surface of the ceiling. In other examples, the crossfire sensor may be located in a cavity of the detector above a surface of the ceiling. At block 310, a hazard may be detected based on an illuminance in the reflected detection path of the crossfire sensor. In some examples, detecting the hazard may comprise detecting a presence of at least one of carbon monoxide and smoke.

Although examples have been described above, other variations and examples may be made from this disclosure without departing from the spirit and scope of these disclosed examples.

1. An apparatus, comprising:
a detector configured to be mounted to a ceiling of a room, the detector comprising a crossfire sensor arranged to fire in a direction parallel to a surface of the ceiling; and
a shade mounted to the detector and having a shading surface arranged parallel to the surface of the ceiling and between the room and the crossfire sensor.

2. The apparatus of claim 1, wherein:
the crossfire sensor comprises a sender and a receiver, the sender configured to fire into a reflected detection path of the receiver; and
the crossfire sensor is configured to generate a signal representing illuminance in the reflected detection path of the receiver.

3. The apparatus of claim 1, wherein the shade is configured to at least partially block light from the room from being detected by the crossfire sensor.

4. The apparatus of claim 1, wherein the shade comprises a permeable material configured to at least partially block light from passing therethrough.

5. The apparatus of claim 1, wherein the shade is configured to permit air flow along a direct path from the room into a detection path of the detector.

6. The apparatus of claim 1, wherein the detector comprises at least one of a smoke detector and a carbon monoxide detector.

7. The apparatus of claim 1, wherein the crossfire sensor is configured to be located at least partially below the surface of the ceiling when the detector is mounted in a recess of the ceiling.

8. The apparatus of claim 7, wherein the shade has an L-shape configuration.

9. The apparatus of claim 7, wherein:
the shading surface of the shade has rectangular shape configured to be oriented parallel to the surface of the ceiling when the detector is mounted in the recess; and
the shade further includes:
a first side member coupled to a first edge of the shading surface of the shade and configured to extend to the ceiling when the detector is mounted in the recess;
a second side member coupled to a second edge of the shading surface of the shade and configured to extend to the ceiling when the detector is mounted in the recess; and
a third side member coupled to a third edge of the shading surface of the shade and configured to extend to the ceiling when the detector is mounted in the recess.

10. The apparatus of claim 1, wherein the crossfire sensor is located in a cavity of the detector and configured to be located above the surface of the ceiling when the detector is mounted in a recess of the ceiling.

11. The apparatus of claim 10, wherein the shade comprises a T-shaped member coupling the shading surface of the shade to the detector.

12. An apparatus, comprising:
a detector configured to be mounted to a wall of a room, the detector comprising a crossfire sensor arranged to fire in a direction parallel to a surface of the wall facing the room; and
a shade mounted to the detector and having a shading surface arranged parallel to the surface of the wall and between the room and the crossfire sensor.

13. The apparatus of claim 12, wherein:
the crossfire sensor comprises a sender and a receiver, the sender configured to fire into a reflected detection path of the receiver; and
the crossfire sensor is configured to generate a signal representing illuminance in the reflected detection path of the receiver.

14. The apparatus of claim 12, wherein the shade is configured to permit air flow along a direct path from the room into a detection path of the detector.

15. The apparatus of claim 12, wherein the crossfire sensor is configured to be located at least partially interior to the surface of the wall when the detector is mounted in a recess of the wall.

16. The apparatus of claim 12, wherein the crossfire sensor is located in a cavity of the detector and configured to be located exterior to the surface of the wall when the detector is mounted in a recess of the wall.

17. A method of operating a detector, comprising:
mounting the detector to a ceiling;
shading a reflected detection path of a crossfire sensor of the detector from light projecting from a room and toward the detector;
permitting air flow along a direct path from the room and into the reflected detection path of the crossfire sensor;
firing the crossfire sensor in a direction parallel to a surface of the ceiling facing the room; and
detecting a hazard based on an illuminance in the reflected detection path of the crossfire sensor.

18. The method of claim 17, wherein the crossfire sensor is located at least partially below the surface of the ceiling.

19. The method of claim 17, wherein the crossfire sensor is located in a cavity of the detector above the surface of the ceiling.

20. The method of claim 17, wherein detecting the hazard comprises detecting a presence of at least one of carbon monoxide and smoke.
